(19) United States
(12) Patent Application Publication
(10) Pub. No.: US 2026/0204243 A1
(43) Pub. Date: Jul. 16, 2026

(54) VEHICLE AND METHOD OF CONTROLLING SOUND IN VEHICLE

(71) Applicants: Hyundai Motor Company, Seoul (KR); Kia Corporation, Seoul (KR)

(72) Inventor: Kyoung Jin Chang, Hwaseong (KR)

(21) Appl. No.: 19/219,282

(22) Filed: May 27, 2025

(30) Foreign Application Priority Data
Nov. 26, 2024 (KR) 10-2024-0170386

(51) Int. Cl. G10H 1/00; G10L 15/18

(52) U.S. Cl. CPC G10H 1/0025; G10H 1/0041; G10L 15/1815; G10H 2210/036; G10H 2210/056; G10H 2210/076; G10H 2210/111; G10H 2220/455; G10H 2240/141

(57) ABSTRACT

A vehicle includes at least a sensor disposed inside the vehicle to detect a voice signal and a vibration signal generated by an occupant, a camera disposed inside the vehicle to capture a video of the occupant, and a processor configured to analyze the voice signal, the vibration signal, and the video of the occupant and analyze the occupant's intention, where the processor is configured to generate a sound source according to the occupant's intention.

### CROSS-REFERENCE TO RELATED APPLICATION

This application claims under 35 U.S.C. § 119(a) the benefit of Korean Patent Application No. 10-2024-0170386, filed on Nov. 26, 2024, the entire contents of which are incorporated herein by reference.

### BACKGROUND

### 1. Technical Field

The present disclosure relates to a vehicle and a method of controlling sound in the vehicle, more particularly, to the vehicle and the method that includes generating sound in the vehicle based on a sensed environment inside the vehicle.

### 2. Description of the Related Art

Recently, technologies of composing music using artificial intelligence have been used. The recently used technologies use a method of selecting several variables required for composing music by simply pressing a button or composing music with the minimum variables required for composing music through simple instructions through voice.

Since these composing methods are methods of allowing a user to select only few key variables, it is difficult to compose and arrange music that maximally reflects the user's intention, such as using the melody and beat desired by the user.

In addition, when these methods are applied to vehicles, there is a problem that it is difficult to communicate at a high level, such as giving instructions required for composing music through actions of occupants (a driver or passengers).

In addition, conventional in-vehicle audio systems typically use a method of allowing a user to select music directly or play a pre-stored sound source, but such a method has a problem that it is difficult to reflect the user's immediate emotional state or intention.

### SUMMARY

The present disclosure is directed to providing a vehicle and a method of controlling the same, which can improve a user's experience by providing a system for identifying emotional and musical intentions of occupants and automatically generating and arranging a sound source suitable for the intentions.

According to the present disclosure, a vehicle includes at least a sensor disposed inside the vehicle to detect a voice signal and a vibration signal generated by an occupant of the vehicle; a camera disposed inside the vehicle to capture an image of the occupant; and a processor configured to: analyze the voice signal, the vibration signal, and the image of the occupant so as to analyze an intention of the occupant; and generate a sound source according to the intention of the occupant.

According to an aspect of the present disclosure, there is provided a vehicle including a sensor unit disposed inside the vehicle to detect a voice signal and a vibration signal generated by an occupant, a camera disposed inside the vehicle to capture an image of the occupant, a first processing unit configured to analyze the voice signal, the vibration signal, and the image of the occupant and analyze an intention of the occupant, and a second processing unit configured to generate a sound source according to the intention of the occupant.

The first processing unit may analyze the voice signal and the vibration signal and calculate music type information, melody information, and beat information to be applied to the sound source.

The first processing unit may calculate the music type information through natural language analysis of the voice signal.

The first processing unit may analyze a frequency and scale of the voice signal and calculate the melody information.

The first processing unit may calculate the beat information through pattern analysis of the vibration signal.

The second processing unit may select a target music stem similar to the music type information, the melody information, and the beat information from a pre-stored music stem library and generate a primary sound source using the target music stem.

The second processing unit may rearrange tracks of the target music stem and then combine the rearranged tracks to generate the primary sound source.

The second processing unit may change at least one of melody and beat of the target music stem and then combine the changed at least one of the melody and beat to generate the primary sound source.

The first processing unit may analyze a motion of the occupant from the occupant's image and match the motion of the occupant with preset arrangement instruction information to calculate an arrangement signal to be applied to the sound source.

The second processing unit may arrange the primary sound source according to the arrangement signal to calculate a final playback sound source.

According to the present disclosure, a method of controlling a vehicle includes: detecting, by at least a sensor, a voice signal and a vibration signal generated by an occupant of the vehicle; capturing, by a camera disposed inside the vehicle, an image of the occupant; analyzing, by a processor, the voice signal, the vibration signal, and the image of the occupant so as to analyze an intention of the occupant; and generating, by the processor, a sound source according to the intention of the occupant.

According to another aspect of the present disclosure, there is provided a method of controlling a vehicle, which includes detecting, by a sensor unit, a voice signal and a vibration signal generated by an occupant, capturing, by a camera disposed inside the vehicle, an image of the occupant, analyzing, by a first processing unit, the voice signal, the vibration signal, and the image of the occupant and analyzing an intention of the occupant, and generating, by a second processing unit, a sound source according to the intention of the occupant.

The analyzing of the intention of the occupant may include analyzing the voice signal and the vibration signal and calculating music type information, melody information, and beat information to be applied to the sound source.

The analyzing of the intention of the occupant may include calculating the music type information through natural language analysis of the voice signal.

The analyzing of the intention of the occupant may include analyzing a frequency and scale of the voice signal and calculating the melody information.

The analyzing of the intention of the occupant may include calculating the beat information through pattern analysis of the vibration signal.

The generating of the sound source may include selecting a target music stem similar to the music type information, the melody information, and the beat information from a pre-stored music stem library and generating a primary sound source using the target music stem.

The generating of the sound source may include rearranging tracks of the target music stem and then combining the rearranged tracks to generate the primary sound source.

The generating of the sound source may include changing at least one of melody and beat of the target music stem and then combining the changed at least one of the melody and beat to generate the primary sound source.

The analyzing of the intention of the occupant may include analyzing a motion of the occupant from the image of the occupant and matching the motion of the occupant with preset arrangement instruction information to calculate an arrangement signal to be applied to the sound source.

The generating of the sound source may include arranging the primary sound source according to the arrangement signal to calculate a final playback sound source.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating a vehicle in communication with other devices to transmit and receive data;

FIG. 2 is a view illustrating modules forming a vehicle according to one embodiment of the present disclosure;

FIG. 3 is a view for describing operations of the vehicle according to the embodiment;

FIGS. 4 to 7 are views for describing operations of a processor according to the embodiment; and

FIG. 8 is a flowchart illustrating a method of controlling a vehicle according to an embodiment.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings.

However, the technical spirit of the present disclosure is not limited to some of the described embodiments, but may be implemented in various different forms, and one or more of the components among the embodiments may be used by being selectively coupled or substituted without departing from the scope of the technical spirit of the present disclosure.

In addition, terms (including technical and scientific terms) used in embodiments of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

Hereinafter, embodiments will be described in detail with reference to the accompanying drawings, and the same or corresponding components are denoted by the same reference numeral regardless of the reference numerals, and overlapping descriptions thereof will be omitted.

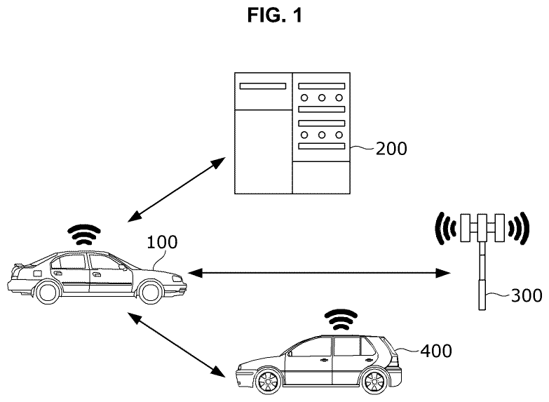

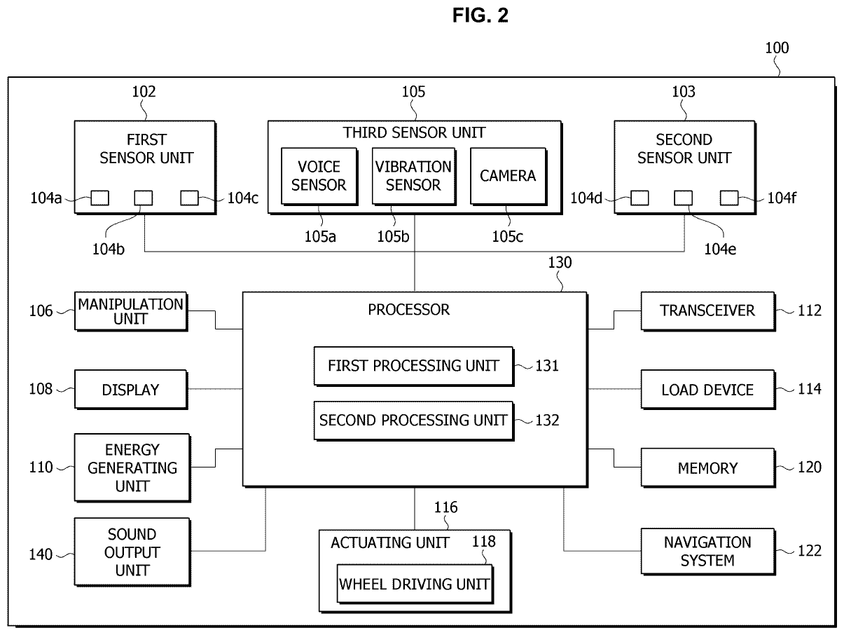

Hereinafter, a vehicle will be described with reference to FIGS. 1 and 2. FIG. 1 is a view illustrating a vehicle in communication with other devices to transmit and receive data.

Referring to FIG. 1, a vehicle 100 may be driven based on electrical energy or fossil energy. In the case of electrical energy, the vehicle 100 may be, for example, a pure battery-based vehicle driven by only a high-voltage battery or may adopt a gas-based fuel cell as an energy source. In addition, a fuel cell may use any form of gas that may generate electrical energy and, for example, a gas in a liquefied state may be charged to the vehicle 100. Here, the gas may be, for example, hydrogen. However, the present disclosure is not limited thereto, and any gas may be applied. In the case of fossil energy, the vehicle 100 may be driven based on fuel such as gasoline, diesel, or a liquefied gas and provided with an internal combustion engine that drives an actuating unit 116 by combustion of the fuel. The engine may be included in an energy generation unit 110 from the perspective of providing a driving rotational force of a wheel to a wheel driving unit 118. As another example, the vehicle 100 may drive the actuating unit 116 selectively using an internal combustion engine based on fossil energy and the energy of an electric battery and may be a hybrid-type vehicle.

The vehicle 100 may be referred to as a movable device. The vehicle 100 is a ground vehicle that travels on the ground and may be a typical car or commercial vehicle, a purpose built vehicle (PBV), or the like. The vehicle 100 may be a four-wheeled vehicle, for example, a car, a sport utility vehicle (SUV), a small truck, or a vehicle with more than four wheels, for example, a bus, a large truck, a container transport vehicle, a heavy equipment vehicle, or the like. Here, the ground vehicle may be referred to as including not only a vehicle that moves on land but also a vehicle that moves underground. The vehicle 100 may be a robot in a broad sense, such as a means of transportation, and the robot may be moved using wheels, tracks, or other moving modules. In the present disclosure, a ground mobility device such as a ground vehicle is mainly described, but unless it contradicts the present disclosure, the present embodiment may also be applied to air mobility devices such as an advanced air mobility (AAM) and an aircraft and water mobility devices such as a ship and a submarine.

The vehicle 100 may be driven by being controlled in an autonomous manner, and the autonomous driving may be implemented as semi-autonomous driving or fully autonomous driving. The fully autonomous driving may be provided as autonomous movement in which a processor 130 of the vehicle 100 has a full control authority without a user's intervention even when a traveling situation is uncertain. The semi-autonomous driving may be provided as autonomous movement that requires a driver's intervention depending on a specific traveling situation. The semi-autonomous driving may be implemented that the processor 130 transfers a control authority to the user to perform manual driving after deactivating autonomous driving in the case of the above situation. According to the level of the autonomous driving defined by the Society of Automotive Engineers (SAE), the semi-autonomous driving corresponds to autonomous driving levels 1 to 4, and the fully autonomous driving corresponds to level 5.

Meanwhile, the vehicle 100 may communicate with other devices 200 and 300 or another vehicle 400. The other devices may include, for example, a server 200 for supporting various types of control, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving and may receive connected data of the vehicle 100 or transmit data required for autonomous driving. To support autonomous driving and various services of the vehicle 100, the server 200 may transmit various types of information and software modules that are used for controlling the vehicle 100 to the vehicle 100 in response to requests and data transmitted from the vehicle 100 and the user device.

The ITS device 300 is, for example, a road side unit (RSU) and may exchange vehicle recognition data, driving control and state data, environmental data near a vehicle, map data, or the like with the vehicle 100 through vehicle-to-infrastructure (V2I) communication to assist the user's driving or support the autonomous driving of the vehicle 100. The vehicle 100 may exchange the above listed data with another vehicle 400 through vehicle-to-vehicle (V2V) communication to support manual driving or autonomous driving.

The vehicle 100 may communicate with another vehicle or other devices based on cellular communication, wireless access in vehicular environment (WAVE) communication, dedicated short range communication (DSRC), short-range communication, or another communication method.

For example, the vehicle 100 may use a communication network such as Long Term Evolution (LTE) or 5G, a Wi-Fi communication network, a WAVE communication network, or the like as a cellular communication network to communicate with the server 200, the ITS device 300, and another vehicle 400. As another example, DSRC or the like used in the vehicle 100 may be used for communication between vehicles. A communication method between the vehicle 100, the server 200, the ITS device 300, another vehicle 400, and the user device is not limited to the above embodiment.

FIG. 2 is a view illustrating modules forming a vehicle according to one embodiment of the present disclosure.

The vehicle 100 may include a sensor unit 102, a manipulation unit 106, a display 108, a load device 114 and a transceiver 112.

The sensor unit 102 may include various types of detectors for detecting various states and situations that occur in an external environment, internal system, user manipulation, and boarding space of the vehicle 100.

Specifically, the first sensor unit 102 may include an outward-facing camera 104a, a light detection and ranging (LiDAR) sensor 104b, a radar sensor 104c, and the like to recognize dynamic and static objects outside the vehicle 100. The camera 104a may recognize an external object as image data while being used in the vehicle 100 to generate image data and transmit the image data to the processor 130. The LiDAR sensor 104b may generate point cloud data as recognized data of an external object and transmit the point cloud data to the processor 130 in order to generate three-dimensional spatial information that identifies at least the shape of the external object. The radar sensor 104c may emit radio waves of a specific frequency to a peripheral area of the vehicle 100 to identify the presence of an external object, a relative distance, speed, direction, and the like to generate radar data through radio waves reflected from the external object. In the present disclosure, the LiDAR sensor 104b is provided as an example, but in another example, the LiDAR sensor 104b may not be mounted.

The first sensor unit 102 may generate object recognition information based on sensing data. The object recognition information may include information about whether an object is present, position information of the object, distance information between the vehicle 100 and the object, and relative speed information between the vehicle 100 and the object. In an embodiment, an external object may be various objects related to the driving of the vehicle 100.

A second sensor unit 103 may include a positioning sensor 104d, a wheel sensor 104e, an attitude sensor 104f, and the like to check a position, speed, driving attitude, and the like of the vehicle. The attitude sensor 104f may include a gyro sensor, an angular velocity sensor, an acceleration sensor, or the like. The attitude sensor may be an inertial measurement unit (IMU) sensor and may include a 3-axis accelerometer and a 3-axis angular velocity meter. The attitude sensor may measure acceleration in a traveling direction x, acceleration in a transverse direction y, acceleration in a height direction z, and yaw, pitch, and roll as an angular speed of the vehicle 100.

The second sensor unit 103 may generate vehicle traveling information based on the sensing data. The vehicle traveling information may be information generated based on data detected by various sensors installed inside the vehicle. For example, the vehicle traveling information may include vehicle attitude information, vehicle speed information, vehicle tilt information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle traveling information may include route information. The route information may be information generated based on a destination input by a vehicle user through the manipulation unit 106. The route information may be information in which a traveling route from a current position of a host vehicle to a destination is displayed on map information when the destination is set. When the destination is not set, the route information may be information that includes a road on which the vehicle is currently traveling and a future traveling route including the road.

A third sensor unit 105 may include a voice sensor 105a for collecting voice signals inside the vehicle, a vibration sensor 105b disposed around occupants, and a camera 105c for capturing images of the inside of the vehicle.

The voice sensor 105a may include at least one microphone disposed inside the vehicle and collect voices and humming sounds of occupants inside the vehicle to generate voice signals.

The vibration sensor 105b may include at least one acceleration sensor or gyro sensor that is disposed at a position at which the occupant's body may reach and measure vibrations generated when a steering wheel, a console box, or a dashboard is tapped inside the vehicle to generate vibration signals.

The camera 105c may capture images of the inside of the vehicle and may be disposed to face a front of an upper body of the occupant to generate image signals generated by capturing images of the occupant's action.

The manipulation unit 106 may be formed as a module manipulated by a user for driving. For example, the manipulation unit 106 may be a steering wheel for manual driving, an automatic or manual transmission, an accelerator pedal, a brake pedal, or the like. The manipulation unit 106 may further include an interface for using, deactivating, and selecting detailed functions of an autonomous driving mode requested by the user so that the user may use the autonomous driving function. To receive various requests related to autonomous driving, the manipulation unit 106 may be composed of, for example, a hard type interface provided at a predetermined position inside the vehicle 100 or a soft type interface through which the display 108 is touchable. According to the specifications of the autonomous driving vehicle, at least one of the steering wheel, the transmission, and the pedal may be omitted. As another example, the manipulation unit 106 may include a module that receives a user's control request for the load device 114 in addition to driving control.

The display 108 may serve as a user interface. The display 108 may display an operation state of the vehicle 100, a control state, route/traffic information, the remaining energy information, a content requested by the driver, and the like to be output by the processor 130. In addition, the display 108 may be formed as a touch screen capable of detecting the driver's input to receive the driver's request that instructs the processor 130.

The load device 114 may be mounted on the vehicle 100 and may be a type of non-driving electrical device excluding a driving power system such as the wheel driving unit 118. The load device 114 is an auxiliary device for receiving power from the energy generation unit 110 and may be, for example, any of various devices installed in an air conditioning system, a lighting system, a seat system, and the vehicle 100. In the present disclosure, a cooling/heating system for cooling or heating at least one of a battery, a fuel cell, an internal combustion engine, an air conditioning system, and a specific area of the vehicle 100 may be further included.

The transceiver 112 may support mutual communication with the server 200, the ITS device 300, the nearby vehicle 400, and the like. The transceiver 112 may include, for example, a module for processing cellular communication, WAVE, DSRC communication, or the like. In the present disclosure, the transceiver 112 may transmit data generated or stored during driving to the server 200 and receive data and a software module transmitted from the server 200. The transceiver 112 may support communication with an electronic device of the occupant inside the vehicle 100. In the present disclosure, the vehicle 100 may transmit and receive data used in the method according to the present disclosure to and from an external device through the transceiver 112.

For example, the transceiver 112 may receive traffic signal information from a traffic signal controller and provide the traffic signal information to the processor 130. In addition, the transceiver 112 may receive a control signal information from the traffic signal controller and provide the control signal information to the processor 130.

In addition, the vehicle 100 may include the energy generation unit 110 and the actuating unit 116.

The energy generation unit 110 may generate and supply power and electric power that are used in a driving power system and a non-driving power system, such as the actuating unit 116. The non-driving power system may include, for example, the sensor unit 102, the manipulation unit 106, the display 108, the load device 114, the transceiver 112, and the like but is not limited thereto, and may include any component that implements sensing, interface, communication, and convenience functions other than components directly involved in a driving operation. When the vehicle 100 is driven based on electrical energy, the energy generation unit 110 may be formed as, for example, an electric battery charged from the outside or formed as a combination of an electric battery and a fuel cell that charges the battery. In the case of a combination of the electric battery and the fuel cell, the energy generation unit 110 may include a tank that stores a material used to produce power for the fuel cell, for example, liquefied hydrogen. When the vehicle 100 is driven based on fossil energy, the energy generation unit 110 may be formed as an internal combustion engine. In addition, when the vehicle 100 is a hybrid type, the energy generation unit 110 may be provided as a combination of the internal combustion engine and the electric battery.

The actuating unit 116 may include at least one module that implements a driving operation and may perform at least one driving operation of longitudinal control such as acceleration and deceleration and lateral control such as steering according to a user request from the manipulation unit 106. To perform the driving operation according to the user's manual manipulation or the instruction of the processor 130 by autonomous driving, the actuating unit 116 may include the wheel driving unit 118, and a mechanical component and electronic module for implementing the driving operation of the wheel driving unit 118. When the vehicle 100 is operated based on electrical energy, the vehicle 100 may include an assembly for transmitting the requested driving operation to the wheel driving unit 118. When the vehicle 100 is operated based on fossil energy, the actuating unit 116 may include a transmission and a gear module for transmitting the power of an internal combustion engine.

The wheel driving unit 118 may include a plurality of wheels, a driving force generation module for generating a driving force and applying the driving force to wheels or transmitting the driving force, a braking module for decelerating the driving of the wheels, a steering module for achieving transverse control of the wheels. When the vehicle 100 is driven based on electrical energy, the driving force generation module may be formed as a motor assembly for generating a driving force based on power output from the electric battery. The braking module of the electricity-based vehicle 100 may further have a regenerative braking function.

A navigation system 122 may provide navigation information. The navigation information may include at least one of map information, set destination information, route information according to destination setting, information about various objects on a route, lane information, and current position information of the vehicle.

The navigation system 122 may receive information from an external device through the transceiver 112 and update pre-stored information. According to an embodiment, the navigation system 122 may be classified as a subcomponent of the manipulation unit 106.

A sound output unit 140 may convert an electrical signal provided from the processor 130 into an audio signal and output the audio signal. To this end, the sound output unit 140 may include one or more speakers.

In addition, the vehicle 100 may include a memory 120 and the processor 130.

The memory 120 may store an application and various types of data for controlling the vehicle 100 and load the application or read or write the data upon receiving a request from the processor 130.

The processor 130 may perform the overall control of the vehicle 100. The processor 130 may be configured to execute applications and instructions that are stored in the memory 120.

The processor 130 may include a first processing unit 131 and a second processing unit 132.

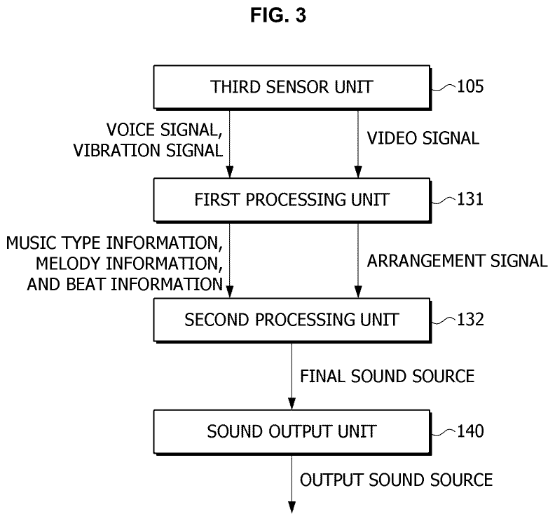

FIG. 3 is a view for describing operations of the vehicle according to the embodiment. Referring to FIG. 3 together, in an embodiment, the processor 130 may collect voice signals, vibration signals, and image signals from the third sensor unit 105, analyze the occupant's intention, automatically generate a sound source, and arrange the sound source.

The first processing unit 131 may analyze the occupant's motion from the occupant's images and match the occupant's motion with preset arrangement instruction information to calculate an arrangement signal to be applied to the sound source.

The first processing unit 131 may serve to receive and process the voice signal, vibration signal, and occupant's images detected by the third sensor unit and analyze the user's intention. The processing unit analyzes various signals and calculates key information for music generation and arrangement.

The first processing unit 131 may analyze the voice signal and the vibration signal and calculate music type information, melody information, and beat information to be applied to the sound source.

For example, the first processing unit 131 may calculate music type information through natural language analysis for the voice signal.

For example, the first processing unit 131 may analyze a frequency and scale of the voice signal and calculate melody information.

For example, the first processing unit 131 may derive beat information through pattern analysis of the voice signal or the vibration signal.

For example, the first processing unit 131 may analyze the occupant's motion from the occupant's images and match the occupant's motion with preset arrangement instruction information to calculate an arrangement signal to be applied to the sound source.

First, the first processing unit 131 may analyze the voice signal received from the third sensor unit and identify the type of the voice signal. The first processing unit 131 may classify the voice signal into language, a humming sound, and a tapping sound. The first processing unit 131 may classify the type of the voice signal into language, a humming sound, and a tapping sound using a deep learning model such as a convolutional neural network (CNN), a recurrent neural network (RNN), a long short-term memory (LSTM), or the like.

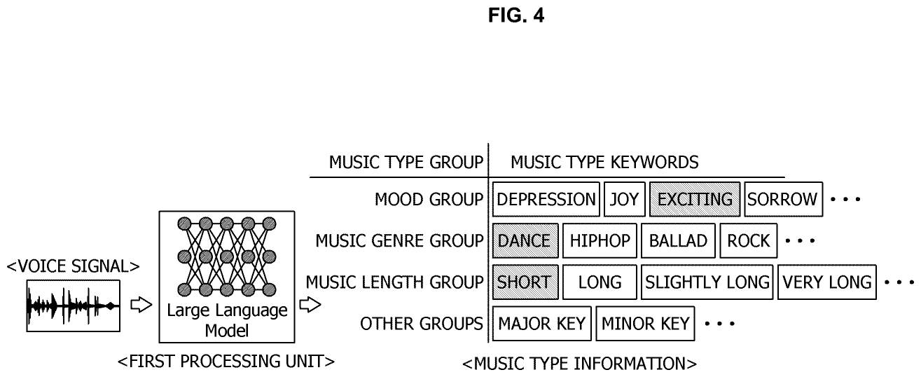

FIGS. 4 to 7 are views for describing operations of the first processing unit 131 according to the embodiment.

Referring to FIG. 4 together, when a voice signal includes language, the first processing unit 131 may derive music type information through natural language analysis for the voice signal. The first processing unit 131 may identify the occupant's intention through a natural language processing algorithm based on a large language model (LLM). The first processing unit 131 may extract keywords such as a mood, genre, and length of music from what a driver tells using a natural language model, and select matching keywords from a pre-configured music type group.

The first processing unit 131 may analyze the user's voice data using an artificial intelligence algorithm and then derive keywords for the type of music (e.g., mood, genre, length, major/minor keys, or the like) desired by the user, and then the second processing unit 132 may define the overall style of the music accordingly.

For example, the first processing unit 131 may select keywords of the mood group such as ‘depression,’ ‘joy,’ ‘exciting,’ ‘sorrow,’ or the like as a result of language analysis of the voice signal.

For example, the first processing unit 131 may select keywords of the music genre group such as ‘dance,’ ‘hip-hop,’ ‘ballad,’ ‘rock,’ or the like as a result of language analysis of the voice signal.

For example, the first processing unit 131 may select keywords of the music length group such as ‘short,’ ‘long,’ ‘slightly long,’ ‘very long,’ or the like as a result of language analysis of the voice signal.

For example, the first processing unit 131 may select keywords of guitar (ETC) such as a ‘major key,’ a ‘minor key,’ or the like as a result of language analysis of the voice signal.

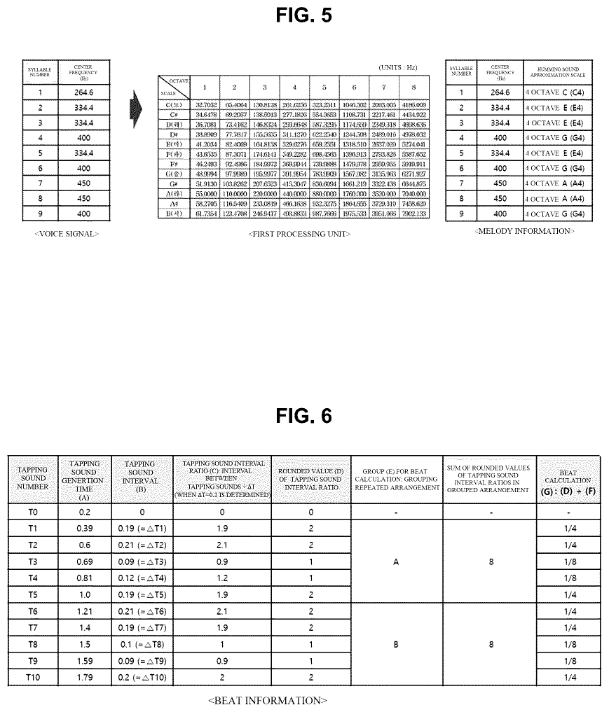

Referring to FIG. 5 together, the first processing unit 131 may analyze a humming sound to be connected to a specific octave and scale based on humming sound frequency information of the voice signal of the user and calculate basic melody information. The melody information may be directly reflected in subsequent music generation by the second processing unit 132.

The first processing unit 131 may analyze the frequency and scale of the humming sound and calculate melody information. Upon receiving the humming sound, the first processing unit 131 may separate the humming sound into syllables, analyze the frequency on the basis of 1/12 octave or 1/24 octave, and determine a center frequency of each syllable.

The first processing unit 131 may select the center frequency with the greatest energy for each syllable, compare the frequency with a standard scale frequency, and match the frequency with the closest scale. Accordingly, the first processing unit 131 may form the melody information of the humming sound. For example, the first processing unit 131 may select 1 to 5 frequencies per syllable, and then when there is a harmonic relationship between the frequencies, a basic frequency of the frequencies in the harmonic relationship may be selected as the center frequency, and when there is no harmonic relationship, the frequency with the greatest energy may be selected as the center frequency.

In addition, the first processing unit 131 may employ a 1/24 octave analysis method to minimize an error between the frequencies.

Referring to FIG. 6 together, the first processing unit 131 may analyze a time interval of the tapping sound included in the voice signal or the vibration signal and calculate the beat information of the music. When the beat information is calculated using the tapping sound of the voice signal, the process of collecting and analyzing the vibration signal may be omitted.

That is, the first processing unit 131 may perform a function of extracting the beat based on the vibration signal generated when the occupant taps a specific part using his or her hand or an object.

The first processing unit 131 may analyze the time interval between the tapping sounds and calculate the beat information. The first processing unit 131 may calculate time intervals ΔT1 to ΔT8 of sounds with a volume greater than or equal to a reference volume whenever the tapping sound occurs and calculate the basic beat based on intervals between the tapping sounds.

In this case, when the occupant sets whether to input a vibration signal through the manipulation unit and then collects vibrations, vibration signals of the occupant can be effectively collected without interference with other signals and noise problems.

The first processing unit 131 may first arbitrarily define a minimum time interval ΔT considering the time interval between the tapping sounds. In this case, a minimum value among the time intervals of the tapping sounds can be defined as an initial value of ΔT. The first processing unit 131 may calculate a difference value between multiples (e.g., multiples of 1 to 3) of ΔT and the intervals of the tapping sounds while slightly increasing the minimum time interval ΔT and finally determine ΔT that minimizes a difference value of the smallest case for all multiples. That is, the first processing unit 131 may determine ΔT that minimizes an error between the interval of the tapping sounds and ΔT. Thereafter, the first processing unit 131 may represent the tapping sound interval ratio C as an integer multiple D by rounding up a value (i.e., a tapping sound interval ratio C) obtained by dividing the interval between the tapping sounds by ΔT. The first processing unit 131 may analyze the arrangement of these values, group repeated sections into one group, and calculate the sum F of rounded values D of all tapping sound interval ratios in the same group. The first processing unit 131 may calculate beat information G by dividing the rounded values D of the tapping sound interval ratios by the sum F.

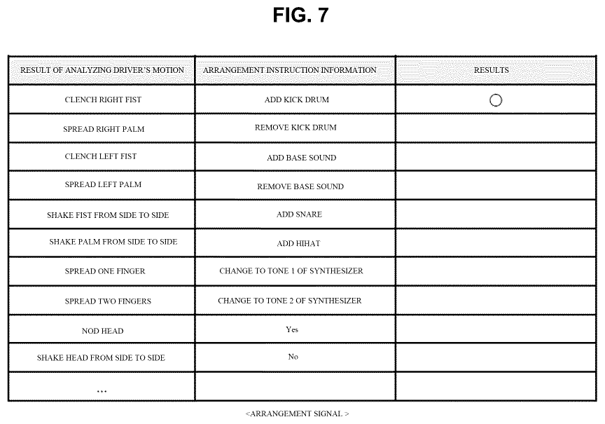

Referring to FIG. 7 together, the first processing unit 131 may analyze the occupant's motion through the occupant's images and match the corresponding motion with the preset arrangement instruction information to calculate the arrangement signal.

The first processing unit 131 analyzes motion data of the occupant captured by the in-vehicle camera and determines the occupant's intention. For example, the first processing unit 131 may recognize the occupant's motion, such as nodding his head, and based on this, generate an arrangement signal that adds drums, removes bass sounds from music, and the like.

The first processing unit 131 may match the predefined arrangement instruction information based on the analyzed motion data to calculate the arrangement signal. For example, the first processing unit 131 may calculate the arrangement signal that adjusts musical elements, such as adding/removing a kick drum, adding/removing a bass sound, and the like, according to the driver's motion. The driver's motion and the arrangement signal may be organized in a predefined and mutually matched state and stored in the memory. The arrangement signal may include musical elements that may be arranged, such as adding/removing a kick drum, adding/removing a bass sound, adding/removing a sound effect, changing a tone, increasing/decreasing a volume, changing a key, and the like.

The first processing unit 131 may recognize the body parts of the driver through a deep learning algorithm (a regional CNN, you only look once (YOLO), or the like), analyze the driver's motion through a deep learning model such as a multi-task CNN, an LSTM, or the like, and calculate arrangement instruction information for the corresponding motion.

The second processing unit 132 may generate a sound source according to the occupant's intention.

The second processing unit 132 may select a target music stem similar to music type information, melody information, and beat information from a pre-stored music stem library and generate a primary sound source using the target music stem.

The second processing unit 132 may rearrange tracks of the target music stem and then combine the rearranged tracks to generate the primary sound source.

In addition, the second processing unit 132 may change at least one of the melody and beat of the target music stem and then combine the changed at least one of the melody and beat to generate the primary sound source.

In addition, the second processing unit 132 may arrange the primary sound source according to the arrangement signal to calculate a final playback sound source.

The second processing unit 132 may serve to generate a sound source according to the occupant's intention and, as needed, calculate the final playback sound source through arrangement. The second processing unit 132 may select an appropriate music stem from the music stem library, combine the selected music stem to generate the primary sound source, and then perform an arrangement suitable for the occupant's intention.

The music stem is data obtained by separating various elements that form music into independent tracks and may refer to data obtained by dividing a piece of complete music into various elements, such as melody, bass, drums, vocals, and guitar, and generating individual tracks.

The music stem library previously stores any type of music stem and metadata about the corresponding sound sources. The metadata may include information such as the mood, genre, length, major/minor keys, melody, and beat of the sound source, and based on this, the second processing unit 132 may search for and select an appropriate music stem.

The second processing unit 132 receives the music type information (mood, genre, length, and the like), melody information, and beat information of the driver, which are analyzed by the first processing unit 131 and compares the information with the metadata of the music stem library. The second processing unit 132 may use a machine learning technique, such as a Kullback-Leibler divergence (KL-Divergence) algorithm, a support vector machine (SVM) algorithm, or the like, as a method of finding similar data by comparing data groups. Accordingly, the second processing unit 132 may designate the most similar music stem as the target music stem.

The second processing unit 132 may select a target music stem similar to music type information, melody information, and beat information from the music stem library previously stored in the memory and generate the primary sound source.

The second processing unit 132 may search the music stem library for various music stems and select a music stem most similar to the music type, melody, and beat information analyzed by the first processing unit 131. The second processing unit 132 may form the most natural music based on the selected music stems and change the sound source to be closer to the basic melody and beat.

The second processing unit 132 may rearrange the selected target music stem or combine tracks to generate the primary sound source.

For example, the second processing unit 132 may generate a new configuration by deleting, adding, or changing tracks of the target music stem and generate the primary sound source.

In addition, the second processing unit 132 may change a part of the melody and beat of the target music stem using the melody information and beat information generated by the first processing unit 131, and then combine the tracks of the target music stem to generate the primary sound source.

After generating the primary sound source, the second processing unit 132 may arrange the sound source track according to the arrangement signal to generate the final playback sound source. The second processing unit 132 may compare the arrangement signal with the metadata of the primary sound source, and when there is a difference greater than or equal to a preset value, the second processing unit 132 may load a new music stem from the music stem library and proceed with reworking. Alternatively, the second processing unit 132 may perform arrangement based on the generated primary sound source when the arrangement signal does not differ from the metadata of the primary sound source by the preset value or more, thereby generating the final sound source.

The second processing unit 132 may add, remove, or change sound source tracks based on the arrangement signal generated by analyzing the occupant's motion. For example, when there is an instruction such as “adding a kick drum” in the arrangement signal, the second processing unit 132 may add the corresponding track to the primary sound source.

The second processing unit 132 may add or remove a specific track to or from the primary sound source according to the arrangement signal to calculate the final sound source. For example, this is a method of adding or removing a kick drum track.

In addition, the second processing unit 132 may change the tone of the sound source track to generate the final sound source. For example, the tone may be changed by replacing an electric guitar track with a piano track.

In addition, the second processing unit 132 may increase or decrease the volume of the primary sound source according to the arrangement signal to generate the final sound source.

When the arrangement work is completed, the second processing unit 132 may generate the final playback sound source and transmit the final playback sound source to the sound output unit. In this case, all the used tracks and arrangement signals may be reflected to generate a complete sound source desired by the occupant.

The processor 130 may reproduce the final playback sound source using the sound output unit disposed in the vehicle.

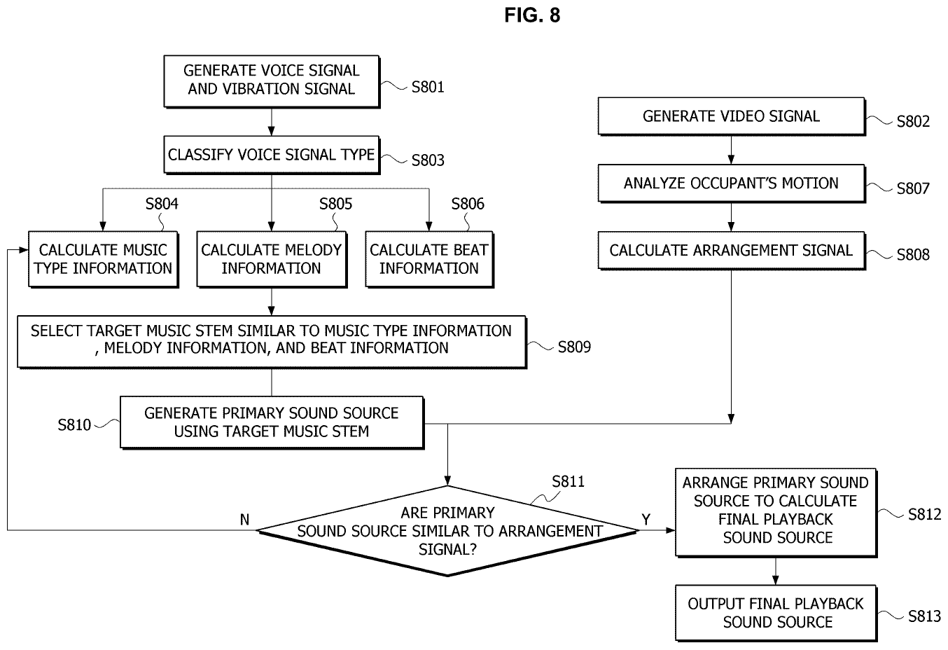

FIG. 8 is a flowchart illustrating a method of controlling a vehicle according to an embodiment.

Referring to FIG. 8, first, the sensor unit detects a voice signal and a vibration signal generated by an occupant (S801).

Subsequently or simultaneously, a camera captures images of the occupant inside the vehicle (S802).

Next, a processor classifies the type of the voice signal (S803).

Next, the processor calculates music type information through natural language analysis for a signal of the voice signal, which is classified as language (S804).

In addition, the processor analyzes a frequency and scale of a signal of the voice signal, which is classified as a humming sound, and calculates melody information (S805).

In addition, the processor calculates beat information through pattern analysis of the vibration signal using the vibration signal (S806).

In addition, the processor analyzes the occupant's motion from the occupant's images (S807).

Next, the processor matches the occupant's motion with preset arrangement instruction information to calculate an arrangement signal to be applied to a sound source (S808).

Next, the processor selects a target music stem similar to music type information, melody information, and beat information from a pre-stored music stem library (S809).

Next, the processor generates a primary sound source using the target music stem. The processor rearranges tracks of the target music stem, then combines the rearranged tracks or changes at least one of the melody and beat of the target music stem, and then combines the changed at least one of the melody and beat to generate the primary sound source (S810).

Next, the processor compares the primary sound source with the arrangement signal (S811).

When a difference value between the primary sound source and the arrangement signal is out of a preset range, the processor re-performs the process of generating the primary sound source.

When the difference value between the primary sound source and the arrangement signal is not out of the preset range, the processor arranges the primary sound source according to the arrangement signal to generate a final playback sound source (S812).

The processor outputs the generated final playback sound source through an audio output unit (S813).

A vehicle and a method of controlling the same according to embodiments can improve a user's experience by providing a system for identifying emotional and musical intentions of occupants and automatically generating and arranging a sound source suitable for the intentions.

The term “unit” used in the present embodiment means a software or hardware component such as a field-programmable gate array (FPGA) or an application-specific integrated circuit (ASIC), and the “unit” performs certain roles. However, the “unit” is not limited to software or hardware. The “unit” may be disposed in an addressable storage medium and configured to reproduce one or more processors. Therefore, examples of the “unit” are components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “units” or separated into additional components and “units.” Additionally, the components and “units” may be implemented to reproduce one or more central processing units (CPUs) in a device or a security multimedia card.

Although the present disclosure has been described above with reference to exemplary embodiments, those skilled in the art will understand that the present disclosure may be modified and changed variously without departing from the spirit and scope of the present disclosure as described in the appended claims.

What is claimed is:

1. A vehicle comprising:
at least a sensor disposed inside the vehicle to detect a voice signal and a vibration signal generated by an occupant of the vehicle;
a camera disposed inside the vehicle to capture an image of the occupant; and
a processor configured to:
analyze the voice signal, the vibration signal, and the image of the occupant so as to analyze an intention of the occupant; and
generate a sound source according to the intention of the occupant.

2. The vehicle of claim 1, wherein the processor analyzes the voice signal and the vibration signal and calculates music type information, melody information, and beat information to be applied to the sound source.

3. The vehicle of claim 2, wherein the processor calculates the music type information through natural language analysis of the voice signal.

4. The vehicle of claim 2, wherein the processor analyzes a frequency and scale of the voice signal and calculates the melody information.

5. The vehicle of claim 2, wherein the processor calculates the beat information through pattern analysis of the vibration signal.

6. The vehicle of claim 2, wherein the processor selects a target music stem similar to the music type information, the melody information, and the beat information from a pre-stored music stem library and generates a primary sound source using the target music stem.

7. The vehicle of claim 6, wherein the processor rearranges tracks of the target music stem and then combines the rearranged tracks to generate the primary sound source.

8. The vehicle of claim 6, wherein the processor changes at least one of melody and beat of the target music stem and then combines the changed at least one of the melody and beat to generate the primary sound source.

9. The vehicle of claim 6, wherein the processor analyzes a motion of the occupant from the image of the occupant and matches the motion of the occupant with preset arrangement instruction information to calculate an arrangement signal to be applied to the sound source.

10. The vehicle of claim 9, wherein the processor arranges the primary sound source according to the arrangement signal to calculate a final playback sound source.

11. A method of controlling a vehicle, the method comprising:
detecting, by at least a sensor, a voice signal and a vibration signal generated by an occupant of the vehicle;
capturing, by a camera disposed inside the vehicle, an image of the occupant;
analyzing, by a processor, the voice signal, the vibration signal, and the image of the occupant so as to analyze an intention of the occupant; and
generating, by the processor, a sound source according to the intention of the occupant.

12. The method of claim 11, wherein analyzing the intention of the occupant includes analyzing the voice signal and the vibration signal and calculating music type information, melody information, and beat information to be applied to the sound source.

13. The method of claim 12, wherein analyzing the intention of the occupant includes calculating the music type information through natural language analysis of the voice signal.

14. The method of claim 12, wherein analyzing the intention of the occupant includes analyzing a frequency and scale of the voice signal and calculating the melody information.

15. The method of claim 12, wherein analyzing the intention of the occupant includes calculating the beat information through pattern analysis of the vibration signal.

16. The method of claim 12, wherein generating the sound source includes:
selecting a target music stem similar to the music type information, the melody information, and the beat information from a pre-stored music stem library; and
generating a primary sound source using the target music stem.

17. The method of claim 16, wherein generating the sound source includes rearranging tracks of the target music stem and then combining the rearranged tracks to generate the primary sound source.

18. The method of claim 16, wherein generating the sound source includes changing at least one of melody and beat of the target music stem and then combining the changed at least one of the melody and beat to generate the primary sound source.

19. The method of claim 16, wherein analyzing the intention of the occupant includes:
analyzing a motion of the occupant from the image of the occupant; and
matching the motion of the occupant with preset arrangement instruction information to calculate an arrangement signal to be applied to the sound source.

20. The method of claim 19, wherein generating the sound source includes arranging the primary sound source according to the arrangement signal to calculate a final playback sound source.
